(19) United States
(12) Patent Application Publication
(10) Pub. No.: US 2023/0282947 A1
(43) Pub. Date: Sep. 7, 2023

(54) CONNECTION ELEMENT FOR CONNECTING TWO ACCUMULATORS

(71) Applicant: SAFT, LEVALLOIS PERRET (FR)

(72) Inventors: Valentin BLONZ, BORDEAUX (FR); Maxence BARDIAU, LE HAILLAN (FR)

(73) Assignee: SAFT, LEVALLOIS PERRET (FR)

(21) Appl. No.: 18/008,386

(22) PCT Filed: Jun. 4, 2021
(86) PCT No.: PCT/EP2021/065052

§ 371 Date: Dec. 5, 2022

(30) Foreign Application Priority Data
Jun. 4, 2020 (FR) FR20 05871

(51) Int. Cl. H01M 50/516; H01M 50/528; H01M 50/209; H01M 50/503

(52) U.S. Cl. CPC H01M 50/516; H01M 50/528; H01M 50/209; H01M 50/503

(57) ABSTRACT

A connection element for electrically, and mechanically connecting in a direction of connection, a first terminal of a first accumulator to a second terminal of a second accumulator, the first terminal and the second terminal protruding in a thickness direction, the connection element comprising a metal body having a first wing suitable for being welded onto the first terminal, a central part, and a second wing suitable for being welded onto the second terminal, the central part having a U-shape or a V-shape, the first wing and the second wing extending along the legs of the “U” or the “V”, respectively, the connection element being less prominent than, or at the same level in the thickness direction as at least one of the first terminal and of the second terminal.

### CROSS REFERENCE TO RELATED APPLICATIONS

The present application is a U.S. National Phase Application under 35 U.S.C. § 371 of International Patent Application No. PCT/EP2021/065052 filed Jun. 4, 2021, which claims priority of French Patent Application No. 20 05871 filed Jun. 4, 2020. The entire contents of which are hereby incorporated by reference.

### FIELD OF THE INVENTION

The present invention relates to a connection element for connecting electrically, and mechanically along a direction of connection, a first terminal of a first accumulator to a second terminal of a second accumulator, the first accumulator and the second accumulator having two connection faces, respectively, extending in the same plane substantially parallel to the direction of connection, the first terminal and the second terminal protruding from one and the other of the two connection faces, respectively, along a thickness direction substantially perpendicular to the plane, the connection element comprising a metal body.

The invention further relates to an assembly comprising the first accumulator, the second accumulator and such a connection element. Such an assembly advantageously forms a battery.

### BACKGROUND

To connect two accumulators together, it is known how to use one or a plurality of busbars. Such connection elements usually comprise aluminum or copper plates directly laser-welded onto the terminals of the accumulators. It is also known how to use screwed connection elements for pressing the busbar plates onto the terminals along the direction of the thickness of the terminals.

However, such connection elements involve providing a non-negligible space above the terminals of the accumulators. For this reason, the compactness of the sets of interconnected batteries, and hence the energy density thereof, is limited.

### SUMMARY

A goal of the invention is thus to provide a means of increasing the energy density of such interconnected sets of batteries.

To this end, the subject matter of the invention relates to a connection element for connecting electrically, and mechanically, along a direction of connection, a lateral surface of a first terminal of a first accumulator to a lateral surface of a second terminal of a second accumulator, the first accumulator and the second accumulator, respectively, having two connection faces extending in a same plane substantially parallel to the direction of connection, the first terminal and the second terminal protruding, respectively, from one and the other of the two connection faces along a thickness direction substantially perpendicular to the plane,
the connection element comprising a metal body having, successively along the direction of connection, a first wing suitable for being welded onto the lateral surface of the first terminal, a central part, and a second wing suitable for being welded onto the lateral surface of the second terminal,
the central part having a U-shape or a V-shape in a view from a first transverse direction, the first transverse direction being parallel to the thickness direction, or perpendicular to the thickness direction and to the direction of connection,
the first wing and the second wing comprising end-pieces which are fastened, respectively, to a first leg and a second leg of the central part, and elongated parts extending from the end-pieces along the first leg and the second leg, respectively, outside the “U” or the “V” toward a base of the central part in a second transverse direction perpendicular to the first transverse direction and the direction of connection, the elongated parts being away from the first leg and the second leg, respectively, along the direction of connection,
the connection element being intended for being less prominent than, or for being at the same level along the thickness direction as at least one of the first terminal and of the second terminal.

According to particular embodiments, the connection element comprises one or a plurality of the following optional features, taken individually or in all technically possible combinations:
the first wing and the second wing, respectively, define a first contact surface and a second contact surface which are flat and intended for being welded to the lateral surfaces of the first terminal and of the second terminal;
the connection element further comprises: a first extension fastened to the first wing and extending on the lateral opposite the central part with respect to the first wing along the direction of connection, the first extension defining a supplementary first contact surface substantially perpendicular to the first contact surface and intended for being welded onto the first terminal; and a second extension fastened to the second wing and extending on the lateral opposite the central part with respect to the second wing along the direction of connection, the second extension defining a supplementary second contact surface substantially perpendicular to the second contact surface and intended for being welded to the second terminal;
the connection element has symmetry with respect to a plane perpendicular to the direction of connection;
the first wing and the second wing extend parallel to the second transverse direction in an unmounted position of the connection element;
the elongated parts of the first wing and of the second wing, and the central part of the body all have, within 10%, the same extension along the second transverse direction;
each of the end-pieces of the first wing and of the second wing comprises a chamfer suitable for an insertion of the connection element between the first terminal and the second terminal along the second transverse direction;
each of the first wing and the second wing, and optionally each of the end-pieces, comprises respectively a chamfer adapted to allow insertion of the connection element between the first terminal and the second terminal in the first transverse direction;
the body is delimited along the first transverse direction by two surfaces substantially perpendicular to the first transverse direction, and consisting at least of the central part, the first wing and the second wing; and
the connection element further comprises at least one electrically insulating element suitable for being interposed between the body and the two connection faces.

The subject matter of the invention further relates to an assembly comprising at least one first accumulator, at least one second accumulator, and at least one connection element, the connection element connecting electrically, and mechanically along the direction of connection, the lateral surface of the first terminal to the lateral surface of the second terminal, the first wing being welded onto the lateral surface of the first terminal, and the second wing being welded onto the lateral surface of the second terminal, the connection element being less prominent along the thickness direction than at least one of the first terminal and of the second terminal.

According to a particular embodiment, the assembly further comprises electrically insulating elements interposed between the two connection faces and the connection element.

### BRIEF DESCRIPTION OF THE DRAWINGS

The invention will be better understood upon reading the following description, given only as an example and making reference to the enclosed drawings, wherein:

FIG. 1 is a schematic perspective view, forming a first embodiment of the invention, of an assembly according to the invention, comprising a connection element,

FIG. 2 is a schematic perspective view of an assembly according to the invention, forming a first variant of the assembly shown in FIG. 1,

FIG. 3 is a schematic perspective view of an assembly according to the invention, forming a second variant of the assembly shown in FIG. 1,

FIG. 4 is a perspective view of the connection element shown in FIGS. 1 to 3.

FIG. 5 is a perspective view of a connection element forming a first variant of the connection element shown in FIG. 4,

FIG. 6 is a perspective view of a connection element forming a second variant of the connection element shown in FIG. 4,

FIG. 7 is a perspective view of a connection element forming a third variant of the connection element shown in FIG. 4,

FIG. 8 is a perspective view of a connection element forming a fourth variant of the connection element shown in FIG. 4,

FIG. 9 is a schematic representation of an assembly forming a second embodiment of the invention,

FIG. 10 is a perspective view of the connection element shown in FIG. 9, forming a fifth variant of the connection element shown in FIG. 1,

FIG. 11 is a schematic, partial perspective view of an assembly according to the invention, forming a fourth variant of the assembly shown in FIG. 1, and

FIG. 12 is a perspective view of a connection element forming a sixth variant of the connection element shown in FIG. 4.

### DETAILED DESCRIPTION

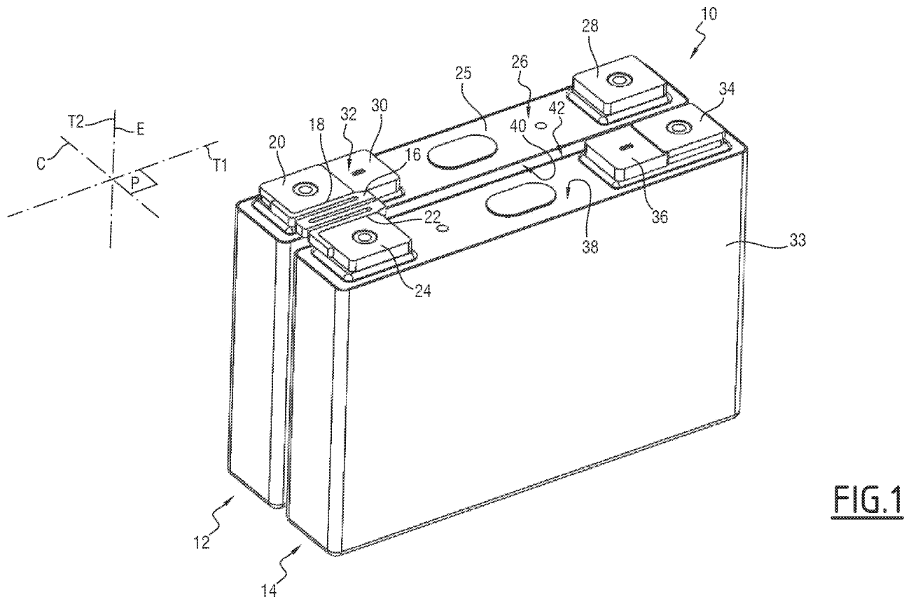

With reference to FIG. 1, an assembly 10 according to a first embodiment of the invention, is described.

The assembly 10 comprises a first accumulator 12, a second accumulator 14, and a connection element 16 electrically and mechanically connecting along a direction of connection C a lateral surface 18 of a first terminal 20 of the first accumulator to a lateral surface 22 of a second terminal 24 of the second accumulator.

The assembly 10 is e.g. intended for being placed in an electric vehicle (not shown), or in space, mobility or energy storage systems, in particular when the compactness of the assembly is an important parameter.

“Accumulator” refers herein to an electrochemical element comprising e.g. an electrochemical bundle (not shown) including an alternation of positive and negative electrodes (not shown) framing separators impregnated with electrolyte. Every electrode consists e.g. of a metal current collector supporting the electrochemically active material on at least one of the faces thereof. The electrode is electrically connected to a current output which provides electrical continuity between the electrode and the external application with which the element is associated. The electrode bundle is placed in a sealed container. The electrochemical element is e.g. of the Li-ion type.

The first accumulator 12 has advantageously a prismatic or parallelepipedal shape, e.g. with a rectangular base.

According to variants (not shown), the base of the prism can have other shapes. The first accumulator 12 includes a casing 25 defining a connection face 26. The first accumulator 12 has another terminal 28 similar to the first terminal 20 but with the opposite polarity, and an identification element 30 located near the first terminal 20 and indicating e.g. a negative polarity of the latter.

In the assembly 10, the casing 25 is made of plastic. It is thus electrically insulating.

The connection face 26 extends in a plane P parallel to the direction of connection C. The connection face 26 has e.g. the same general shape as the base of the prism of the first accumulator 12, i.e. same is rectangular.

The first terminal 20 and the other terminal 28 of the first accumulator 12 protrude from the connection face 26 along a thickness direction E substantially perpendicular to the plane P.

In the example, the thickness direction E is substantially vertical. A first transverse direction T1 of the connection element 16 is defined, the first transverse direction being parallel to the thickness direction E. A second transverse direction T2 is further defined substantially perpendicular to the first thickness direction E and to the direction of connection C.

The first terminal 20 and the other terminal 28 have e.g. a generally parallelepipedal shape and have a square shape with rounded corners in a view along the thickness direction E.

The lateral surfaces 18 and 22 are opposite along the direction of connection C, and are substantially parallel to each other.

The other terminal 28 is located opposite the first terminal 20 on the connection face 26 along the first transverse direction T1.

The identification element 30 has e.g. a generally parallelepipedal shape and is advantageously adjacent to the terminal 20. The identification element 30 includes an upper face 32 parallel to the connection face 26 and displaying a negative sign indicating the polarity of the first terminal 20.

The second accumulator 14 is advantageously structurally equivalent to the first accumulator 12.

According to variants (not shown), the second accumulator 14 differs from the first accumulator 12 by structural features, in particular shape features, or electrical features.

The second accumulator 14 thus comprises a casing 33, another terminal 34 located opposite the other terminal 28 of the first accumulator 12, an identification element 36 indicating the negative polarity of the other terminal 34, and a connection face 38 extending in the plane P.

The second terminal 24 is located opposite the first terminal 20 along the direction of connection C.

Thus, the first accumulator 12 and the second accumulator 14 are connected in series by the connection element 16 and the two large lateral sides 40, 42 thereof are opposite each other along the direction of connection C.

Of course, other arrangements of the first accumulator 12 and of the second accumulator 14 are possible.

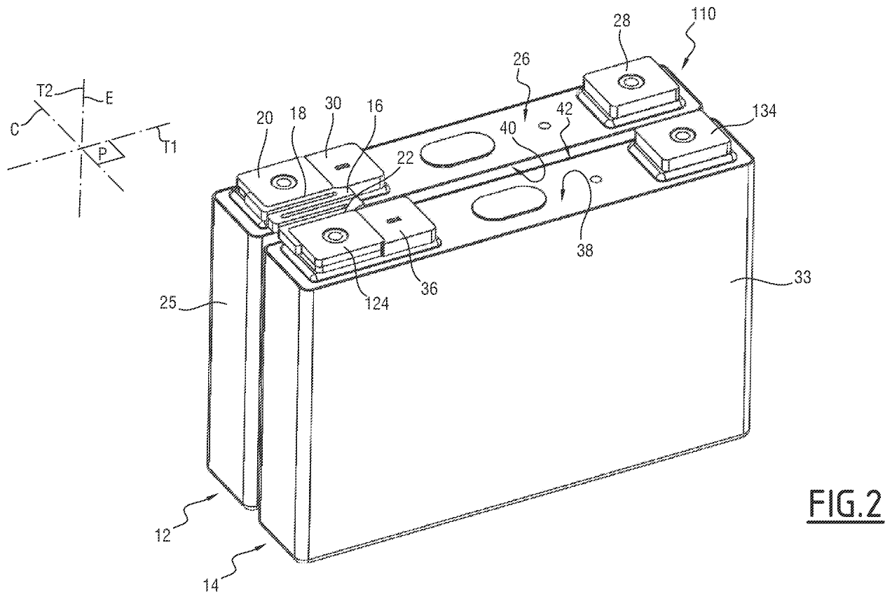

With reference to FIG. 2, an assembly 110 forming a first variant of the assembly 10 shown in FIG. 1, is described. Similar elements bear the same numerical references and will not be described again. Hereinafter, only the differences will be described in detail.

In the assembly 110, the first accumulator 12 and the second accumulator 14 are no longer head-to-tail as shown in FIG. 1, but parallel to each other.

Thus, the second terminal 124 is the equivalent of the other terminal 34 shown in FIG. 1. The second terminal 124 thus has a negative polarity as indicated by the identification element 36.

The other terminal 134 is the equivalent of the first terminal 24 shown in FIG. 1. The other terminal 134 thus has a positive polarity.

The second terminal 124 and the other terminal 134, respectively, are opposite the first terminal 20 and the other terminal 28 of the first accumulator 12 along the direction of connection C.

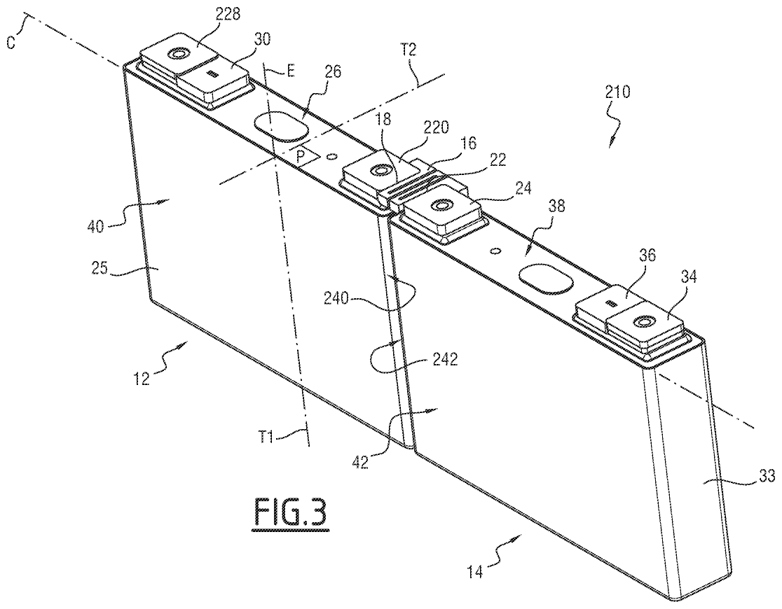

With reference to FIG. 3, an assembly 210 forming a second variant of the assembly 10 shown in FIG. 1, is described. Hereinafter, only the differences will be described.

In the second variant, the first accumulator 12 and the second accumulator 14 are mounted in parallel like in the second variant shown in FIG. 2, but same are opposite each other, respectively, through two small sides 240, 242 thereof along the direction of connection C.

The connection element 16 connects a first terminal 220 of the first accumulator 12 to the second terminal 24 of the second accumulator 14.

The first terminal 220 is the equivalent of the second terminal 28 shown in FIG. 1.

The first accumulator 12 further includes another terminal 228 with negative polarity, as indicated by the identification element 30. The other terminal 228 is located on the connection face 26 located opposite the first terminal 220 along the direction of connection C and not along the first transverse direction T1.

Similarly, the other terminal 34 of the second accumulator 14 is located on the connection face 38 opposite the second terminal 24 along the direction of connection C, and not in the first transverse direction T1.

It should be noted that, in FIG. 3, the connection element 16 is placed along a certain direction along the first transverse direction T1. It could, in a variant not shown, be placed in the opposite direction along said direction.

In fact, the identification elements 30 and 36 are adjacent to the other terminals 34 and 228 and are located away from the connection element 16, which authorizes the two modes of positioning of the connection element with respect to the first terminal 220 and to the second terminal 24.

Other variants of the assembly 10 are possible, with more than two accumulators, and more connection elements connecting some of the terminals of said accumulators, in series or in parallel or further in a combined manner.

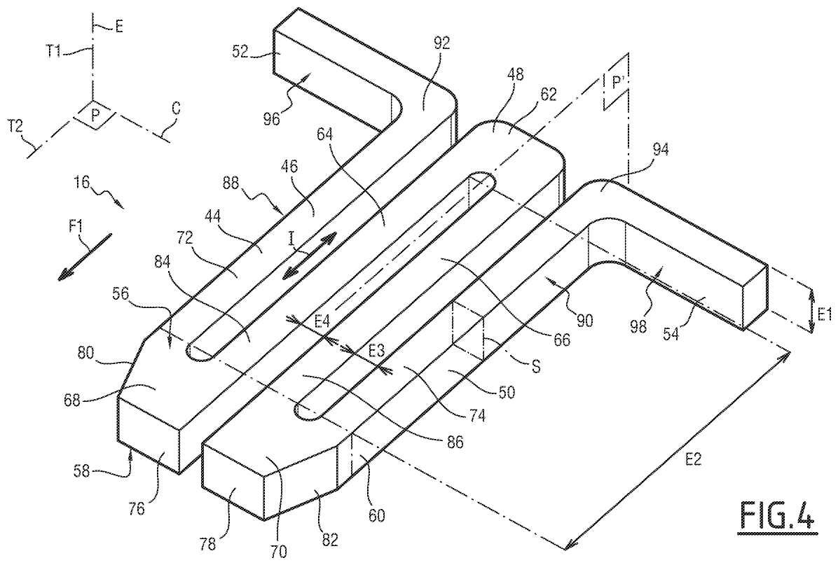

With reference to FIG. 4, a description will now be given for the connection element 16 connecting the first terminals 20, 220 to the second terminals 24, 124 of the assemblies 10, 110 and 210 shown in FIGS. 1 to 3.

The connection element 16 is less prominent in the thickness direction E than the first terminal 20, 220 and the second terminal 24, 124. In particular, the connection element 16 not extending above the first terminal 20, 220 and the second terminal 24, 124; in particular, the connection element is not screwed onto the terminals and does not cap same.

In a variant, the connection element 16 is as prominent along the thickness direction E as either of the first terminal 20, 220 and of the second terminal 24, 124.

As can be seen in FIG. 4, the connection element 16 has a thickness E1 along the thickness direction E, the thickness E1 being advantageously comprised between 1 millimeter and 5 millimeters, preferentially between 2 millimeters and 4 millimeters, and e.g. equal to about 3 millimeters.

In the example, the connection element 16 consists of a body 44 made of electrically conducting material and suitable for being laser-welded to the terminals, e.g. a metallic material.

According to variants (not shown), the connection element 16 can comprise other elements, whether or not of metal, e.g. for facilitating the handling thereof by an operator (not shown), such as non-slip surfaces.

In succession along the direction of connection C, the body 44 comprises a first wing 46 suitable for being welded onto the lateral surface 18 of the first terminal 24, 224, a central part 48 with a “U” shape in a view along the first transverse direction T1, and a second wing 50 suitable for being welded onto the lateral surface 22 of the second terminal 24, 124. Advantageously, the body 44 further comprises a first extension 52 fastened onto the first wing 46 and extending on the side opposite the central part 48 with respect to the first wing along the direction of connection C, and a second extension 54 fastened to the second wing 50 and extending on the side opposite the central part 48 with respect to the second wing along the direction of connection C.

In the example shown in FIGS. 1 to 4, the connection element 16 has a symmetry with respect to a plane P′ perpendicular to the direction C, with respect to which the first wing 46 and the first extension 52, on the first hand, and the second wing 50 and the second extension 54, on the other hand, are symmetrical.

In a view along the first transverse direction T1, which, in the example, is also the thickness direction E, the body 44 has a “W” shape providing same with a certain mechanical elasticity along the direction of connection C.

In the first transverse direction T1, the body 44 is e.g. delimited by two surfaces 56, 58 substantially perpendicular to the first transverse direction T1, and formed by the central part 48, the first wing 46 and the second wing 50.

Between the two surfaces 56, 58, the body 44 is delimited by a lateral surface 60 substantially parallel to the transverse direction T1 and further consisting of the first wing 46, the central part 48 and the second wing 50.

In the example shown, the body 44 is a straight prism the surface 58 of which can be considered as the base with a “W” shape.

If the casing 25 is electrically insulating, the surface 58 can be pressed against the connection faces 26, 38.

As can be seen in FIGS. 1 to 3, the surface 56 is advantageously substantially at the same level as the top of the first terminal 20, 220 and of the second terminal 24, 124 in the thickness direction E.

The central part 48 comprises a base 62, a first leg 64 and a second leg 66 extending parallel to the second transverse direction T2.

As a variant, the central part 48 has a “V” shape, in a view along the first transverse direction T1.

The base 62 is located substantially at the same level as the first extension 52 and the second extension 54 in the second transverse direction T2.

The base 62 is e.g. thicker than the extensions in the second transverse direction T2. The base 62 is also thicker in said direction than the first leg 64 and the second leg 66 in the direction of connection C.

The first leg 64 and the second leg 66 are symmetrical to one another with respect to the plane P′, and are e.g. parallel to one another.

The first leg 64 and the second leg 66 advantageously have a constant cross-section perpendicular to the second transverse direction T2, e.g. a rectangular [cross-section].

The first wing 46 and the second wing 50 comprise end-pieces 68, 70 fastened to the first leg 64 and the second leg 66, respectively, and elongated parts 72, 74 extending from the end-pieces, along the first leg and the second leg, respectively, outside the “U” toward the base 62 in the second transverse direction T2.

In the example shown, the end-pieces 68, 70 include front faces 76, 78, respectively, e.g. perpendicular to the second transverse direction T2, and chamfers 80, 82 suitable for allowing the connection element 16 to be inserted between the first terminal 20 and the second terminal 24 in the second transverse direction T2.

The chamfers 80, 82 flare with respect to each other in the second transverse direction T2 towards the base 62.

The end-pieces 68, 70 are advantageously fastened to ends 84, 86 of the first leg 64 and of the second leg 66 opposite the base 62 in the second transverse direction T2.

The end-pieces 68, 70 are e.g. thicker in the second transverse direction T2 than the first leg 64 and the second leg 66 in the direction of connection C.

The elongated parts 72, 74 are e.g. parallel to the first leg 64 and to the second leg 66, respectively, of the central part 48 in an unmounted position of the connection element 16. The elongated parts 72, 74 define a first contact surface 88 and a second contact surface 90, respectively, which are flat and intended for being edge welded onto the lateral surfaces 18, 22 of the first terminal 20 and of the second terminal 24.

The elongated parts 72, 74 advantageously have constant cross-sections perpendicular to the second transverse direction T2, e.g. rectangular [cross-section].

E.g. the elongated parts 72, 74, on the one hand, and the central part 48 of the body 44, on the other hand, have, within 10%, the same extension E2 in the second transverse direction T2.

The elongated parts 72, 74, the first leg 64 and the second leg 66 have cross-sections S advantageously suitable for providing the connection element 16 with a fuse function. E.g. the sections of the elongated parts 72, 74, of the first leg 64 and of the second leg 66 are substantially identical to each other.

In the example shown, the first extension 52 and the second extension 54 extend perpendicularly to the elongated parts 72, 74, respectively. The first extension 52 and the second extension 54 are parallel to the direction of connection C in the unmounted position in the connection element 16.

In the example shown, the first extension 52 and the second extension 54 are fastened to ends 92, 94 of the elongated parts 72, 74 which are opposite the end-pieces 68, 70 in the second transverse direction T2.

The first extension 52 and the second extension 54 define a first supplementary contact surface 96 and a second supplementary contact surface 98, substantially perpendicular to the first contact surface 88 and to the second contact surface 90.

The supplementary contact surfaces 96 and 98 are suitable for being welded onto the first terminal 20 and the second terminal 24, respectively.

The assembly of the assemblies 10, 110, 210 will now be briefly explained.

First, the first accumulator 12 and the second accumulator 14 are placed in the respective positions thereof, as shown in FIGS. 1 to 3.

Next, the connection element 16 is inserted between the first terminal 20, 220 and the second terminal 24, 124 along the second transverse direction T2 along the direction (arrow F1) going from the base 62 of the central part 48 toward the end-pieces 68, 70 of the first wing 46 and of the second wing 50. The chamfers 80, 82 facilitate the insertion.

When the assembly is finished, the connection element 16 is in the mounted position as shown in FIGS. 1 to 3, wherein the first contact surface 88, the second contact surface 90, the first supplementary contact surface 96, and the second supplementary contact surface 98 are in contact with the lateral surfaces of the first terminal 20, 220 and of the second terminal 24, 124.

The first contact surface 88, the second contact surface 90, the first supplementary contact surface 96, and the second supplementary contact surface 98 are then rigidly attached to the terminals by welding, advantageously using a laser (not shown) according to a technique known per se.

The elongated parts 72, 74 are away from the first leg 64 and the second leg 66 respectively along the direction of connection C. E.g. the gap E3 between the elongated part 74 and the second leg 66 is constant in the second transverse direction T2, and is advantageously equal to the gap E4 between the first leg 64 and the second leg 66, as such advantageously constant in the second transverse direction T2.

During functioning, the connection element 16 lets a current I (FIG. 4) flow from the first terminal 20, 220 towards the second terminal 24, 124 or vice-versa, depending on the polarity of the terminals.

Due to the “W” shape thereof, the connection element 16 absorbs the variations in distance between the first terminal and the second terminal along the direction of connection C, resulting from the possible heating of the first accumulator 12 and of the second accumulator 14 during the functioning thereof.

Due to the above-described features, the connection element 16 provides an effective electrical connection between the first terminal and the second terminal without occupying any space above the terminals in the thickness direction E. Thus, the assemblies 10, 110, 210 have a better compactness and are more energy dense. Such assemblies can thus be used for delivering more energy for the same occupied volume, compared to existing solutions.

Furthermore, due to the shape thereof, the connection element 16 behaves like a spring. Once mounted, same leaves clearance between the first accumulator 12 and the second accumulator 14 in the direction of connection C so as to compensate for any swelling of the accumulators.

Optionally, depending on the shape given thereof, the connection element 16 incorporates a fuse function, depending on the current flow cross-section S which would have been defined.

Due to the shape thereof, the connection element 16 can be used for connecting the first accumulator 12 and the second accumulator 14 according to the wishes of the user, in series, in parallel, etc.

The manufacture of the connection element 16 is simple. E.g. the manufacture can be carried out by extruding a bar and slicing the bar into sections.

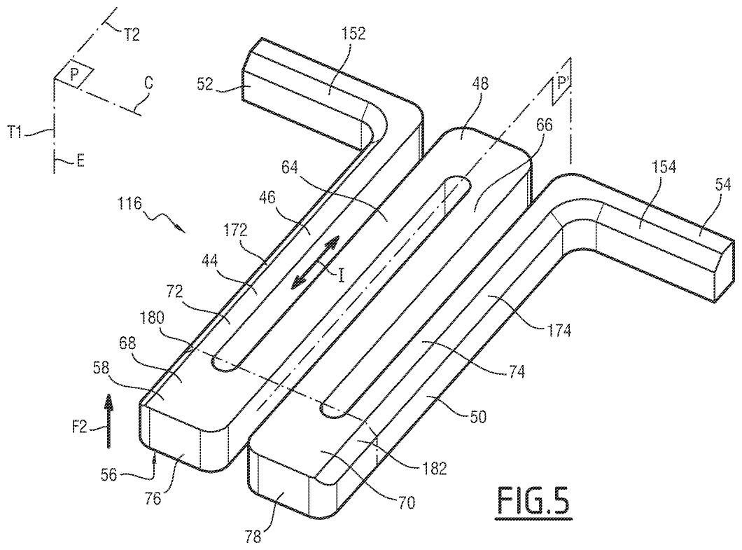

With reference to FIGS. 5 to 8, the connection elements 116, 216, 316 and 416 are described, forming a first variant, a second variant, a third variant and a fourth variant, respectively, of the connection element 16 shown in FIGS. 1 to 4. The connection elements 116 to 416 are equivalent to the connection element 16. Similar elements will not be described again. When the elements bear a numerical reference, the reference is identical to the reference used in FIG. 4. Hereinafter, only the differences will be described in detail.

As can be seen in FIG. 5, in the connection element 116, the end-pieces 68, 70 of the first wing 46 and of the second wing 50 do not include the chamfers 80, 82 suitable for facilitating the insertion of the connection element 16 along the direction of the arrow F1 (FIG. 4).

On the other hand, the elongated parts 72, 74 comprise chamfers 172, 174 suitable for inserting the connection element 116 between the first terminal 20, 220 and the second terminal 24, 124 in the thickness direction E, i.e. perpendicular to the plane P and not parallel to the plane P.

Such insertion is represented in FIG. 5 by an arrow F2.

Advantageously, the end-pieces 68, 70, the first extension 52 and the second extension 54 further include chamfers 180, 182, 152, 154 located in the extension of the chamfers 172, 174, so as to facilitate the insertion.

The chamfers 172, 174 flare in the first transverse direction T1 from the surface 58 towards the surface 56.

Due to such chamfers, the connection element 116 is not a prism.

It should be noted that, in FIG. 5, the connection element 116 is shown upside down with respect to FIG. 4 in the thickness direction E. The connection element 116 has the surface 58 oriented toward the top of FIG. 5, the surface 58 being intended for being applied against the connection faces 26, 38 of the first accumulator 12 and of the second accumulator 14.

The connection element 116 functions in a similar manner to the connection element 16 and has the same advantages.

The connection element 116 can advantageously be manufactured by extruding a bar and by slicing the bar into sections, and by machining the bar.

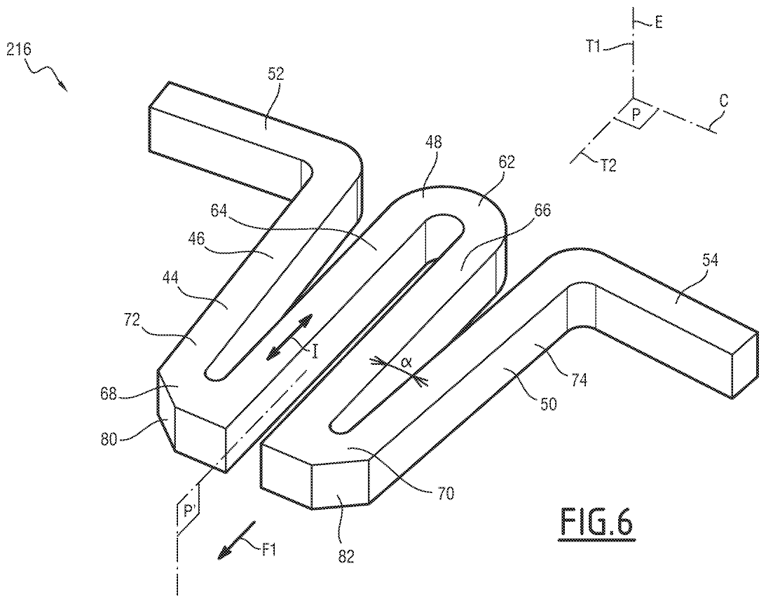

As can be seen in FIG. 6, the connection element 216 differs from the connection element 16 in the shape of the base of the central part 48, which is more rounded, e.g. with a semicircular shape, in a view from the first transverse direction T1.

The elongated parts 72, 74 do not extend parallel to the first leg 64 and to the second leg 66, but form an angle α with the latter.

E.g. the angle α is comprised between 3 and 10 degrees in the unmounted position shown in FIG. 6.

Once the connection element 216 is inserted between the first terminal and the second terminal, the angle α becomes substantially zero. Such initial inclination makes it possible to make sure that the connection element 216, once installed between the first accumulator 12 and the second accumulator 14, is in compression.

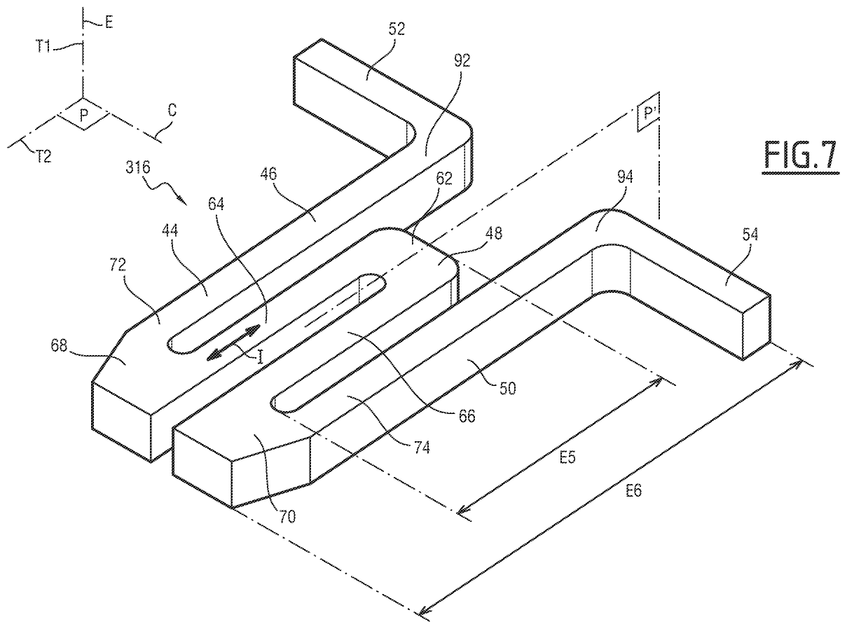

As can be seen in FIG. 7, the connection element 316 includes a central part 48 shorter than the part of the connection element 16 in the second transverse direction T2.

Thus, the base 62 of the central part 48 is not located at the ends 92, 94 of the elongated parts 72, 74 of the first wing 46 and the second wing 50, but between the end-pieces 68, 70 and the ends 92, 94.

E.g. the central part 48 has an extension between E5 in the second transverse direction T2, which is comprised between 40% and 75% of the total length E6 of the connection element 316 in said direction.

Such shortening of the central part 48 makes it possible to modulate the elasticity of the connection element 316 in the direction of connection C.

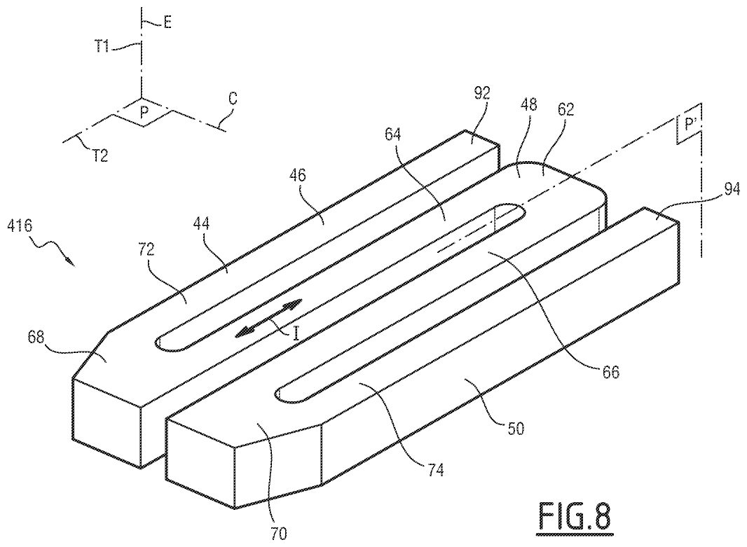

As can be seen in FIG. 8, the connection element 416 does not have the first extension 52 and the second extension 54 shown in FIG. 4.

The ends 92, 94 of the elongated parts 72, 74 of the first wing 46 and of the second wing 50 are located at the same level as the base 62 of the second central part 48 in the second transverse direction T2.

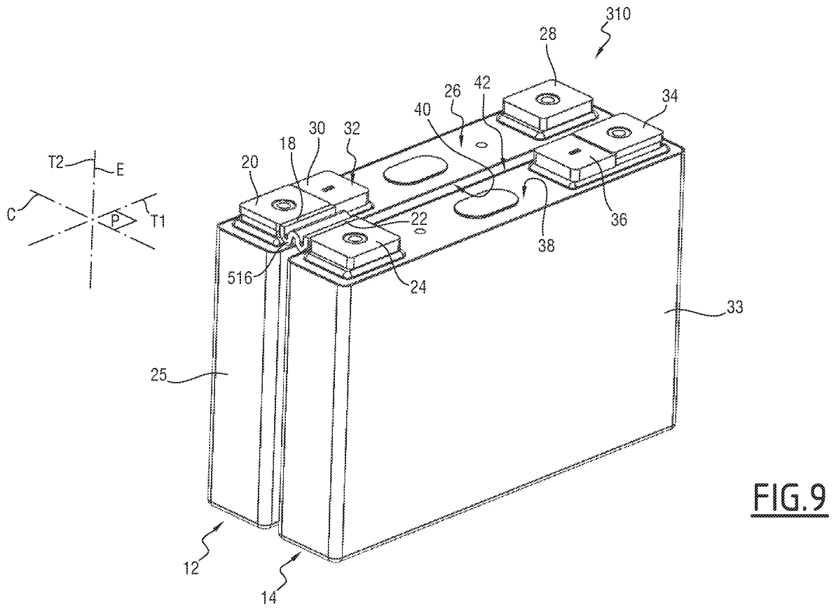

With reference to FIG. 9, an assembly 310 forming a second embodiment of the invention, is described. Hereinafter, only the differences will be described in detail.

The assembly 310 comprises a first accumulator 12 and a second accumulator 14 structurally identical to the accumulators shown in FIG. 1, and arranged in the same way.

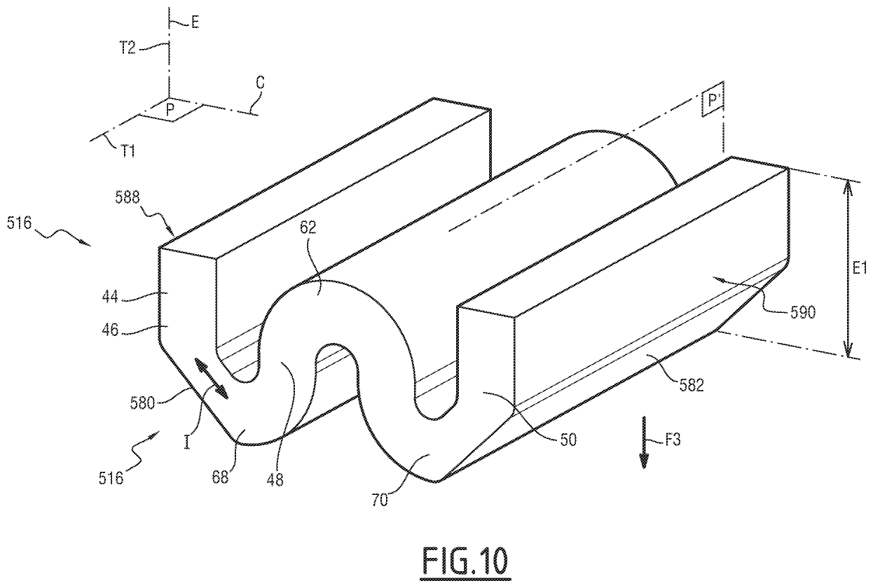

The assembly 310 differs in connection element 516 thereof shown in FIG. 10, and which forms a fifth variant of the connection element 16 shown in FIG. 1.

In the connection element 516, the central part 48 has a “U” shape along a first transverse direction T1 which is not parallel to the thickness E, but which is perpendicular to the thickness direction E and to the direction of connection C.

The connection element 516 also has a small thickness E1 along the thickness direction E, which allows same to be less prominent than the first terminal 20 and the second terminal 24 which are shown in FIG. 9.

The connection element 516 is also prismatic in the first transverse direction T1, i.e. parallel to the plane P, and not perpendicularly like in the other connection elements described above.

The base 62 of the central part 48 is rounded, and e.g. semicircular, in a view along the first transverse direction T1 like in the connection element 216 shown in FIG. 6.

The end-pieces 68, 70 of the first wing 46 and the second wing 50 include chamfers 581, 582 suitable for facilitating the insertion of the connection element 516 between the first terminal 20 and the second terminal 24, along the thickness direction E. Such insertion is shown by an arrow F3 in FIG. 10.

The chamfers 580, 582 are parallel to the transverse direction T1 and flare in the second transverse direction T2 toward the base 62 of the central part 48, as is the case for the chamfers 80, 82 of the connection element 16 shown in FIG. 4.

The first wing 46, the central part 48 and the second wing 50 are much shorter than in the connection element 16, since same extend in the thickness direction E inside the thickness E1, so that the connection element 516 is not more prominent than the terminals in the thickness direction E.

On the other hand, the first wing 46, the central part 48 and the second wing 50 have an extension greater than the extension of the element 16 in the first transverse direction T1.

The connection element 516 does not have the first extension 52 and the second extension 54.

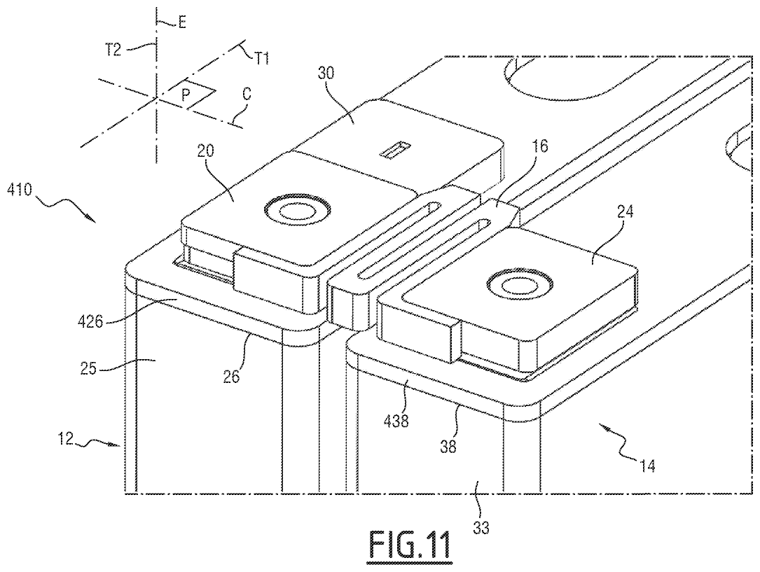

With reference to FIG. 11, an assembly 410 forming a variant of the embodiment shown in FIG. 1, is described. Hereinafter, only the differences will be described in detail.

The casings 25, 33 of the first accumulator 12 and of the second accumulator 14 are no longer made of a plastic material, but of an electrically conducting metallic material.

Electrically insulating elements 426, 438 are interposed between the connection faces 26, 38 and the connection element 16 in order to prevent any short-circuit.

The elements 426, 438 are e.g. rigidly attached to the first accumulator 12 and to the second accumulator 14, respectively.

As a variant, the elements 426, 438 are independent of the accumulators.

The elements 426, 438 cover all or part of the connection faces 26, 38, in particular in the vicinity of the connection element 16.

The elements 426, 438 e.g. are made of a plastic material, or are plates equivalent to the plates used for manufacturing printed circuits. Electronic boards (PCB, Flex Circuit, SMU, etc.) for measuring one or a plurality of state parameters of electrochemical elements (temperature, voltage, etc.) can also be used as electrically insulating elements 426, 438.

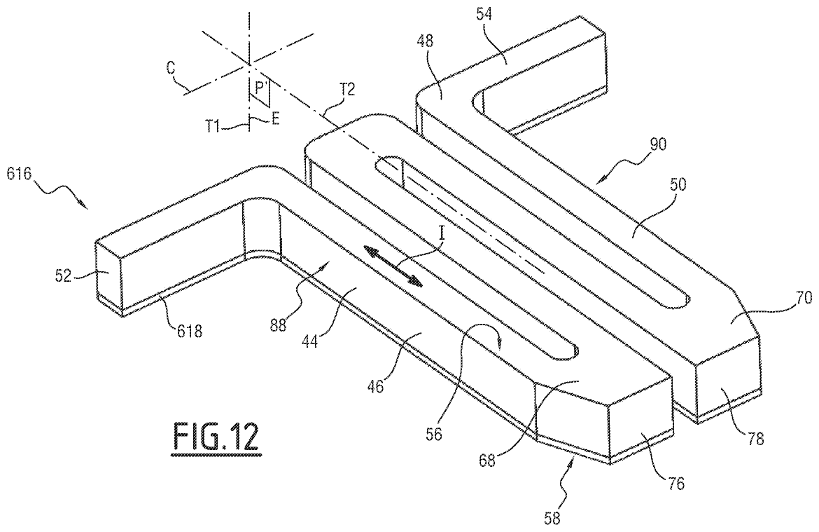

With reference to FIG. 12, a connection element 616 forming a variant of the connection element 16 shown in FIG. 4, is described. Hereinafter, only the differences will be described in detail.

The connection element 616 is more particularly used when the housings 25, 33 are made of an electrically conducting metallic material.

The connection element 616 comprises an electrically insulating element 618 suitable for being interposed between the body 44 and the connection faces 26, 38 in order to prevent any short-circuit.

The element 618 e. g. is made of plastic, or is a plate equivalent to the plates used for manufacturing printed circuits. Similarly, electronic boards (PCB, “flex Circuit”, SMU, etc.) for measuring one or a plurality of state parameters of electrochemical elements (temperature, voltage, etc.) can also be used as electrically insulators 618.

The element 618 advantageously covers the entire surface 58 of the body 44.

1. A connection element configured to connect electrically, and mechanically along a direction of connection, a lateral surface a first terminal of a first accumulator to a lateral surface of a second terminal of a second accumulator, the first accumulator and the second accumulator, respectively, having two connection faces extending in a same plane parallel to the direction of connection, the first terminal and the second terminal, respectively, protruding from one and the other of the two connection faces along a thickness direction perpendicular to the plane,
the connection element comprising a metal body having, successively along the direction of connection, a first wing configured to be welded onto the lateral surface the first terminal, a central part, and a second wing configured to be welded onto the lateral surface the second terminal,
the central part having a U-shape or a V-shape in a view from a first transverse direction, the first transverse direction being parallel to the thickness direction, or perpendicular to the thickness direction and to the direction of connection,
the first wing and the second wing comprising end-pieces fastened respectively to a first leg and a second leg of the central part, and elongated parts extending from the end-pieces respectively along the first leg and the second leg outside the “U” or “V” toward a base the central part in a second transverse direction perpendicular to the first transverse direction and to the direction of connection, the elongated parts being spaced apart from the first leg and the second leg respectively along the direction of connection,
the connection element configured to be less prominent than, or to be at the same level in the thickness direction as at least one of the first terminal and of the second terminal.

2. The connection element according to claim 1, wherein the first wing and the second wing respectively define a first contact surface and a second contact surface which are planar and configured to be welded onto the lateral surfaces of the first terminal and of the second terminal.

3. The connection element according to claim 2, further comprising:
a first extension fastened to the first wing and extending on the side opposite the central part with respect to the first wing in the direction of connection, the first extension defining a first supplementary contact surface perpendicular to the first contact surface and configured to be welded onto the first terminal, and
a second extension fastened to the second wing and extending on the side opposite the central part with respect to the second wing along the direction of connection, the second extension defining a second supplementary contact surface perpendicular to the second contact surface and configured to be welded onto the second terminal.

4. The connection element according to claim 1, having a symmetry with respect to a plane perpendicular to the direction of connection.

5. The connection element according to claim 1, wherein the first wing and the second wing extend parallel to the second transverse direction in an unmounted position of the connection element.

6. The connection element according to claim 1, wherein the elongated parts of the first wing and of the second wing, on the one hand, and the central part of the body, on the other hand, have, within 10%, a same extension in the second transverse direction.

7. The connection device according to claim 1, wherein each of the end-pieces of the first wing and of the second wing includes a chamfer configured to be an insertion of the connection element between the first terminal and the second terminal, in the second transverse direction.

8. The connection element according to claim 1, wherein each of the first wing and the second wing includes a chamfer respectively configured to be an insertion of the connection element between the first terminal and the second terminal, in the first transverse direction.

9. The connection element according to claim 1, wherein the body is delimited in the first transverse direction by two surfaces perpendicular to the first transverse direction, and formed at least by the central part, the first wing and the second wing.

10. The connection element according to claim 1, further comprising at least one electrically insulating element capable to be interposed between the body and the two connection faces.

11. An assembly comprising at least one first accumulator, at least one second accumulator, and at least one connection element according to claim 1, the connection element connecting electrically, and mechanically along a direction of connection, the lateral surface of the first terminal to the lateral surface of the second terminal,
the first wing being welded to the lateral surface of the first terminal, and the second wing being welded to the lateral surface of the second terminal,
the connection element being less prominent in the thickness direction than at least one of the first terminal and of the second terminal.

12. The assembly according to claim 11, further comprising electrically insulating elements interposed between the two connection faces and the connection element.

13. The connection element according to claim 1, wherein each of the end-pieces includes a chamfer respectively, suitable for an insertion of the connection element between the first terminal and the second terminal, in the first transverse direction.
